(19) United States
(12) Patent Application Publication
(10) Pub. No.: US 2018/0239506 A1
(43) Pub. Date: Aug. 23, 2018

(54) ACTIVATION SYSTEM FOR CONTROLLING INTERACTIVE DEVICES

(71) Applicant: Michael Edmond ARZOUMANIAN, WEST BLOOMFIELD, MI (US)

(72) Inventor: Michael Edmond ARZOUMANIAN, WEST BLOOMFIELD, MI (US)

(21) Appl. No.: 15/898,999

(22) Filed: Feb. 19, 2018

Related U.S. Application Data
(60) Provisional application No. 62/461,101, filed on Feb. 20, 2017.

(51) Int. Cl. G06F 3/0484; G06F 1/16

(52) U.S. Cl. CPC G06F 3/0484; G06F 3/0488; G06F 1/1686; G06F 1/1626

(57) ABSTRACT

An activation system includes an interactive device that requires activation, an activation device configured to authorize the activation the interactive device based on received user input, and a user input device communicatively coupled to the interactive device and the activation device configured to receive the user input, submit the user input to the activation device, receive an activation authorization signal from the activation device, and activate the interactive device. Example interactive devices include arcade games, a gambling machines, coin-operated devices, door locks, etc. A user input device such as a tablet based computer connected with a legacy or dated interactive device and communicatively coupled to the activation device allows for such a legacy or dated interactive device having a legacy activation input interface to be activated with more flexible techniques.

### CROSS-REFERENCE TO RELATED APPLICATIONS

The present application claims the benefit of priority to U.S. Provisional Patent Application No. 62/461,101 filed Feb. 20, 2017. The entire subject matter of these priority documents, including specification claims and drawings thereof, is incorporated by reference herein.

### BACKGROUND

### 1. Field of the Invention

The present disclosure relates to a novel activation system for controlling various interactive devices using a tablet type computing device, or similar platform, to directly or indirectly interface, activate, and control the interactive devices.

### 2. Background

Interactive devices, such as arcade video game systems, gambling machines, hotel room door locks, and the like, typically require individual activation prior to use by a user. To date, all user interfaces for activation devices in these usage categories, is performed by coin usage mechanisms, touch or push buttons, and swipe/insert card hardware. These products may or may not include a touch sensitive display that will provide the user with specific and fixed information related to usage of the product currently in use by that user (i.e., credit available in the game or credit on the user credit card). The user interface communicates to a server and may or may not include video or picture and data capability, (to date, few of the products on the market have camera capability and none in a portable platform). As of now, the interface is used only for the purpose of initiating usage of the product, reporting product usage data and to control the cost of using the product. These previous devices/products cannot or do not provide the ability to communicate with sophisticated portable devices (smart phones or similar platforms) or remote RFID cards.

Interactive devices can be purchased and used for many years. However, over this usage lifespan, interactive devices typically cannot be physically upgraded or changed to interface with new or updated technology such as a tablet computing device. It can be difficult for an establishment having many legacy interactive devices to switch to a modern activation system. Moreover, legacy devices might have different activation interfaces. Accordingly, there is a need for a flexible activation system for activating interactive devices.

### SUMMARY

An activation system for controlling interactive devices uses a tablet computing device, or similar platform, to directly or indirectly interface, activate, and control an interactive device. A tablet computing device, or the like, controls and communicates with the interactive device, communicates to the user, communicates to local or remote servers, data storage/analysis devices, provides a complete yet unlimited user interactive interface, and interfaces to social media with user results, including video or still picture and data transmissions from tablet and device mounted camera.

A tablet, or similar platform, or other portable or fixed intelligent platform that will allow the user to use a remote intelligent device such as cell phone or any NFC enabled peripheral or similar device including products with communication capability such as RFID cards and or other similar products that provide data access from the device for usage to activate or otherwise communicate with hotel industry products, the gaming and arcade products, or other similar interactive devices. The features and abilities afforded by this type of product interface provide a degree of control and interconnection not currently realized within the noted industries or similar industries. These features include, but are not limited to, control and communication to and with the noted products (arcade, gaming, hotel, etc.) through an intelligent platform that allows significant ability to manage and control the user interface and therefore the products, provide a database on usage activity, an avenue for user engagement and or advertising, and a communication basis that would allow immediate or latent engagement of Social media by the user or the business deploying the product.

In particular, a tablet, or similar platform, computing device is provided for installation on, or communication with interactive devices, including but not limited to: arcade industry equipment or arcade industry gaming products for the purpose of control or product usage, hotel industry products that are directly or indirectly programmable and provide a user interface of any kind, and slot machine industry or gaming/gambling products that have a user interface that could in any way communicate with a portable intelligent platform or tablet, or similar platform, to activate the games, game doors or game features. Furthermore, the tablet, or similar platform, or portable interactive platform can send signals or user and device information to a remote computing device or server for the purpose of accounting, record keeping or data accumulation and analysis of which may also be used to, in any way, interact with local or remote social media or business communications. Furthermore any such device, either as a tablet, or similar platform, or other portable intelligent platform, in such noted or similar applications that has a built in camera that is used for any of the outlined applications.

An activation system according to a first aspect of this disclosure includes an interactive device that requires activation, an activation device configured to authorize the activation the interactive device based on received user input, and a user input device communicatively coupled to the interactive device and the activation device configured to receive the user input, submit the user input to the activation device, receive an activation authorization signal from the activation device, and activate the interactive device.

An activation system according to a second aspect of this disclosure further includes a portable device including the user input. The user input device includes a sensor configured to detect the user input from the portable device. In an activation system according to a third aspect of this disclosure, the sensor includes a camera, a near field communication sensor, an RFID sensor, a magnetic sensor, or an optical sensor. In an activation system according to a fourth aspect of this disclosure, the user input device includes a user-facing camera configured to image a user operating the interactive device.

In an activation system according to a fifth aspect of this disclosure, the user input device include a social media integration unit configured to create posts to one or more social media systems regarding a usage of the interactive device. In an activation system according to a sixth aspect of this disclosure, the activation device is computer system communicating with the user input device via a computer network and having computer instructions and logic for determining that the interactive device should be activated based on the received user input. In an activation system according to a seventh aspect of this disclosure, a database is communicatively coupled to the activation device and stores data used by the activation device in determine whether to activate the interactive device.

In an activation system according to a eighth aspect of this disclosure, the interactive device includes an activation input interface, which is electrically connected to the user input device, configured to allow the user input device to activate the interactive device. In an activation system according to a ninth aspect of this disclosure, the activation input interface conforms to a first electrical signaling protocol or standard and the user input device conforms to a second electrical signaling protocol or standard, and an activation stick intermediates the connection between the user input device and the interactive device by converting electrical signals between the first and second electrical signaling protocols or standards. In an activation system according to a tenth aspect of this disclosure, the interactive device is an arcade game, a gambling machine, a coin-operated device, a door lock, or the like.

### BRIEF DESCRIPTION OF THE DRAWINGS

FIG. 1 depicts a tablet, or similar platform, based system for controlling interactive devices.

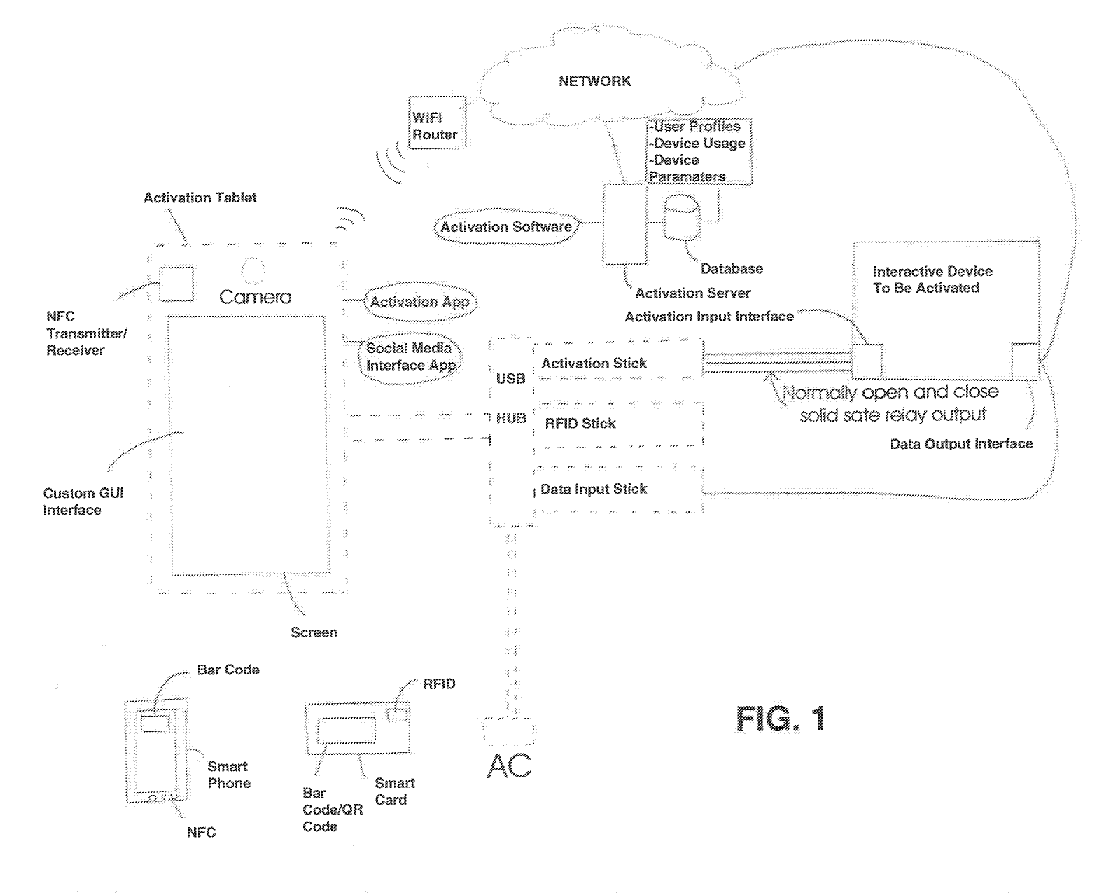

FIG. 2 depicts a flowchart of a method of activating and controlling an interactive device

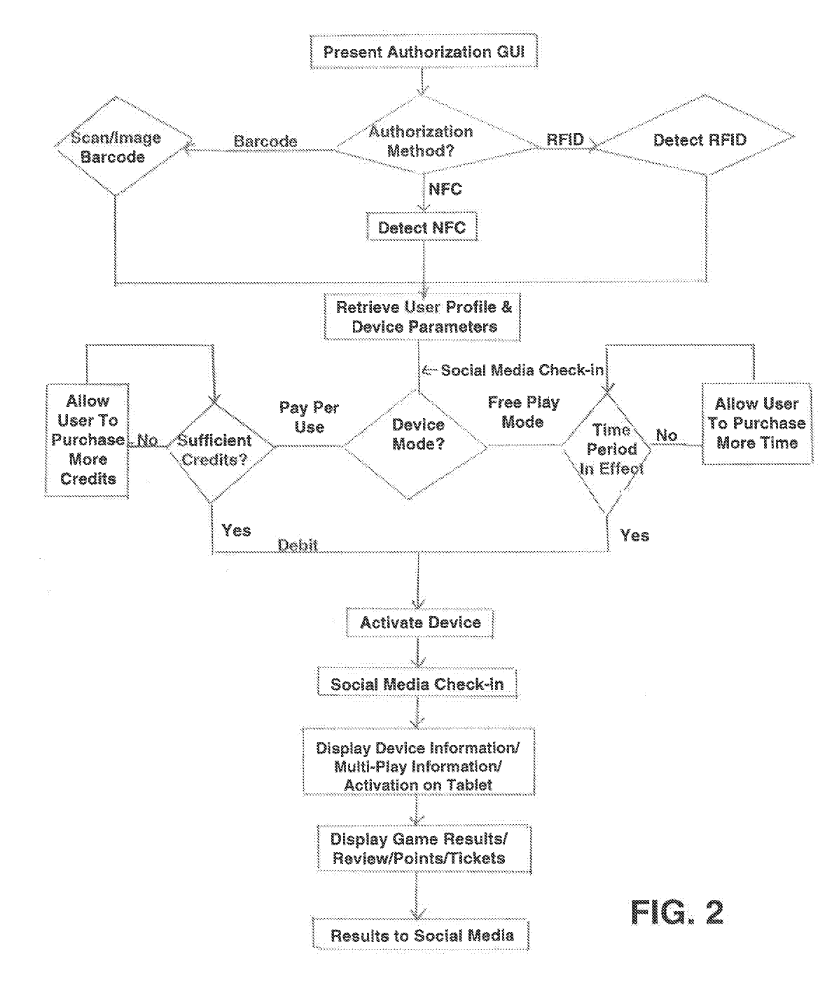

### DETAILED DESCRIPTION

A tablet, or similar platform, based system for controlling and or communicating to interactive devices includes at least one interactive device. As an example, such an interactive device includes an arcade game, a casino gambling machine, a hotel room door, etc. The interactive device includes an input interface for receiving electronic signals for controlling the activation of the device and other communication and data transfer. The interactive device also includes an output interface for outputting device usage and control information or signals. The interactive device includes usage parameters including parameters determining whether the device is to be operated in a pay-per-use mode, a free-play use mode, or data communication mode. The device parameters can also include particular costs for using the device in pay-per-use mode, bonus play or awarded play, as well as particular time periods available for free-play mode. The device usage parameters may be stored on the device itself or stored in an activation server database. The device usage parameters may also be transferred to the tablet, or similar platform, from the device that is being controlled or communicated with.

An activation server is a server-based computing device on a local or remote network. The activation server is configured with activation software for determining whether an interactive device should be activated. The activation server communicates with a database for storing information and data, including user profiles, device parameters, device usage information, etc. The activation server can have bi-directional communication with the interactive device for receiving or setting device parameters, for receiving device usage information, or other data exchange that may be necessary or useful for various applications.

A tablet, or similar platform, accepts input from a user and communicates with the interactive device as well as with an activation server. The tablet, or similar platform, typically may be a hand-held computing device (portable or mounted), having at least a touch screen user interface, a processor, and memory. The equivalent operational features could be integrated or embedded into existing or future developed devices thereby providing the same type of user interface and control without the need for a separate tablet attached to the interactive device. The tablet, or similar platform, has one or more software applications, or apps, configured to present a customized graphical user interface to the user and to communicate with other servers and devices such as the interactive device, the activation server, and social media servers. The tablet, or similar platform, may further include a camera for imaging the user. The tablet, or similar platform, includes a near field communication (NFC) interface for interacting with an NFC interface on a smart phone or similar portable platform.

The tablet, or similar platform, can communicate directly or indirectly with the interactive device. In one approach, the table includes a universal serial bus (USB) interface for connecting with USB peripherals and devices. An activation stick and or cables attach to the USB interface and provides a communication pathway for activating an interactive device. For example, the interactive device could have a standardized activation interface to which the activation stick or cable(s) conforms. When the tablet, or similar platform, determines that the device should be activated, the tablet, or similar platform, communicates with the activation stick or via the cable activating the interactive device according to the standardized activation interface. The timing, sequencing, ordering, encoding, etc. of the activation signals sent to the interactive device by the activation stick and/or cables may be controlled by tablet and may be specified for the particular interactive device. The USB interface of the tablet, or similar platform, can also allow for the connection of an RFID reader/stick or cable if such a reader is not included directly with the tablet, or similar platform. The RFID reader is configured to activate an RFID chip and read the output thereof.

A user interacts with the tablet, or similar platform, via the touch screen interface. In addition, the user can have a smart phone and/or a smart card/entertainment card. The smart phone includes a screen and software for identifying the user. Also, the smart phone can be capable of communicating with the tablet, or similar platform, using NFC. The entertainment card could include an RFID chip for identifying the user. In the event such features are embedded in the interactive device, the user would initiate the communication, control, or usage thereof via such built-in hardware/software and user interface.

As described above, the activation tablet acts as a user input device. The smart phone and smart card independently act as a portable device containing user input data. The activation server, alone or in combination with the database and data network, acts as an activation device.

### Usage

Activation of a device is controlled by activation software operating on a local or remote activation server in coordination with an activation app operating on the tablet, or similar platform device, external to or embedded into the interactive device. When a user wants to use an interactive device, the user would approach the tablet, or similar platform, attached to or embedded within the device and follow the GUI prompts provided on the tablet, similar platform, or embedded features on the interactive device. For example, the interface would prompt the user to authenticate themselves via a smart phone, similar device or entertainment card, using RFID or NFC. The tablet, or similar platform, can communicate with a smart phone using NFC to receive user authentication information. In another approach, a bar code or magnetic strip on the entertainment card or displayed on the screen of the smart phone can be imaged with the camera on the tablet, or similar platform, or with a dedicated scanner included or attached to the tablet, or similar platform. Also, the tablet, or similar platform, could be provided with an RFID reader to read an RFID chip in the entertainment card. With any of these approaches, the tablet, or similar platform, will authenticate the identity of the user. A user may be required to submit an electronic profile at an earlier time, such as through a website, app, or dedicated kiosk, which would be saved to an activation server database.

Upon authentication, the user profile will be retrieved and the operating parameters of the interactive device will be retrieved. A device may be configured to operate on a pay-per-use basis, or might be configured to allow free-play for a given time period or my be configured to accept or transmit data and information and or performance parameters of the device. Additionally, these device parameters could be set differently for different users. Thus, it would be determined from the operating parameters and the user profile whether the device is to be operated on a pay-per-use basis, time play basis, or a free-play basis. If the device is to be operated on a free-play basis or time play basis, it must further be determined if the time period is currently in effect. If the free-play or time play period is not in effect, the tablet, or similar platform, could present the user with the opportunity to purchase or otherwise extend the free-play period.

If the device is to be operated on a pay-per-use basis, it must be determined if the user has sufficient credits to operate the device. If the user has insufficient credits associated with their profile, the tablet, or similar platform, could present the user with the option of purchasing additional credits or converting accumulated rewards/tickets/points/etc. into usable credits.

If the device is to be operated for communicating data between the devices, it must be determined if the user has authorization for this usage. If the user has such authorization, the tablet, or similar platform, could provide information that specifies usage and operating parameters or to obtain data related to device performance and usage.

Upon determining that the device should be activated, the user's account is debited in the case of a pay-per-use device. Subsequently, the device is activated for use by the user. The activation app on the tablet controls the activation stick attached to the USB interface to send an activation signal via the activation stick or cable to the interactive device. The activation signal may be composed of electrical pulses of a particular timing, encoding, sequence, etc. necessary to activate the particular device.

At this point, there may be a post to social media indicating that the device is in use by the user. While the device is in use, output from the device can be provided directly or indirect via a server to the tablet, or similar platform. Such output from the device could include usage time, points, rewards, earnings, scores, multi-player information and images, advertisements, etc. At the conclusion of use, device usage information, such as scores, points, earnings, rewards, tickets, etc. provided by the device can be displayed on the tablet, or similar platform. Additionally, social media posts at this time can include such device usage information, images from the device, screen shots, replays, camera images, as well as images from the tablet, or similar platform, camera.

Game results, including rewards, tickets, etc. may be provided directly or indirectly to the tablet for display to the user. In one approach, the USB interface of the tablet may further include an input interface for receiving data from the interactive device. In another approach, data may be sent from the interactive device to a local or remote server and then accessed by the table via the local or remote server. Alternatively, or in addition to displaying such data on the tablet screen, a result kiosk having a display screen may be configured to receive and display the results.

Social media platforms, such as Facebook, Twitter, etc, allow users to share their experience with their network of friends. The tablet, or similar platform, includes a social media integration app that can post pictures and information on a user's experience to social media platforms. The interactive device owner or operator, such as an arcade or casino, would have a social media identity or account to which pictures or data pertaining to the user's experience is posted. Additionally, the user profile might include social media credentials for the user such that the tablet, or similar platform, could post to the user's social media account.

Information posted to social media platforms could include check-in information that identifies the particular timing and location that a user uses the interactive device. The camera on the tablet, or similar platform, including situations where such features are embedded into the interactive device, if so equipped, could be activated to take a picture of the user at check-in time, during operation of the device, or at the conclusion of the usage of the device. Such pictures could be included with any postings to social media platforms. If the interactive device allows for bi-directional communication with the tablet, or similar platform, the posts to social media could also include information about the user's usage of the device, such as scores, points, levels, performance, rewards, tickets, etc.

Additionally, by interfacing with the user's social media profiles, targeted or user-specific advertisements could be displayed on the tablet, or similar platform. As disclosed herein, the social media integration is accomplished via an app on the tablet, or similar platform. However, it should be apparent that server based software could implement the social media integration and could further communicate with the tablet, or similar platform, for use of the camera.

What is claimed is:

1. An activation system, comprising:
an interactive device requiring an activation;
an activation device configured to authorize the activation the interactive device based on received user input; and
a user input device communicatively coupled to the interactive device and the activation device configured to receive the user input, submit the user input to the activation device, receive an activation authorization signal from the activation device, and activate the interactive device.

2. The activation system according to claim 1, further comprising:
a portable device including the user input,
wherein the user input device includes a sensor configured to detect the user input from the portable device.

3. The activation system according to claim 2, wherein the sensor includes one of a camera, a near field communication sensor, an RFID sensor, a magnetic sensor, and optical sensor.

4. The activation system according to claim 1, wherein the user input device includes a user-facing camera configured to image a user operating the interactive device.

5. The activate system according to claim 1, wherein the user input device include a social media integration unit configured to create posts to one or more social media systems regarding a usage of the interactive device.

6. The activation system according to claim 1, wherein the activation device is computer system communicating with the user input device via a computer network and having computer instructions and logic for determining that the interactive device should be activated based on the received user input.

7. The activation system according to claim 1, further comprising a database communicatively coupled to the activation device and storing data used by the activation device in determine whether to activate the interactive device.

8. The activation system according to claim 1, wherein the interactive device includes an activation input interface, which is electrically connected to the user input device, configured to allow the user input device to activate the interactive device.

9. The activation system according to claim 8, wherein the activation input interface conforms to a first electrical signaling protocol or standard and the user input device conforms to a second electrical signaling protocol or standard, and wherein an activation stick intermediates the connection between the user input device and the interactive device by converting electrical signals between the first and second electrical signaling protocols or standards.

10. The activation system according to claim 1, wherein the interactive device is one of an arcade game, a gambling machine, a coin-operated device, and a door lock.

11. A method for activating an interactive device, comprising:
receiving user input data from a user input device;
submitting the user input data to an activation device communicatively coupled to the user input device;
receiving an activation authorization signal from the activation device;
activating the interactive device via the user input device;

12. The method for activating an interactive device according to claim 11, wherein the user input date received by the user input device is provided by a portable device containing the user input, and wherein the user input device includes a sensor configured to detect the user input from the portable device.

13. The method for activating an interactive device according to claim 12, wherein the sensor includes one of a camera, a near field communication sensor, an RFID sensor, a magnetic sensor, and optical sensor.

14. The method for activating an interactive device according to claim 11, wherein the user input device includes a user-facing camera configured to image a user operating the interactive device.

15. The method for activating an interactive device according to claim 11, wherein the user input device include a social media integration unit configured to create posts to one or more social media systems regarding a usage of the interactive device.

16. The method for activating an interactive device according to claim 11, wherein the activation device is computer system communicating with the user input device via a computer network and having computer instructions and logic for determining that the interactive device should be activated based on the received user input.

17. The method for activating an interactive device according to claim 11, wherein the interactive device includes an activation input interface, which is electrically connected to the user input device, configured to allow the user input device to activate the interactive device.

18. The method for activating an interactive device according to claim 17, wherein the activation input interface conforms to a first electrical signaling protocol or standard and the user input device conforms to a second electrical signaling protocol or standard, and wherein an activation stick intermediates the connection between the user input device and the interactive device by converting electrical signals between the first and second electrical signaling protocols or standards.

19. The method for activating an interactive device according to claim 11, wherein the interactive device is one of an arcade game, a gambling machine, a coin-operated device, and a door lock.
